(19) United States
(12) Patent Application Publication
(10) Pub. No.: US 2004/0257457 A1
(43) Pub. Date: Dec. 23, 2004

(54) System and method for optical data transfer

(76) Inventors: Donald J. Stavely, Windsor, CO (US); Mark J. Bianchi, Fort Collins, CO (US); Norman C. Pyle, Greeley, CO (US); Angelica Quintana, Ft. Collins, CO (US); Wilfred F. Brake, Ft. Collins, CO (US)

Correspondence Address: HEWLETT-PACKARD COMPANY, Intellectual Property Administration, P.O. Box 272400, Fort Collins, CO, 80527-2400, US

(21) Appl. No.: 10/465,418

(22) Filed: Jun. 19, 2003

(51) Int. Cl. H04N 5/222

(52) U.S. Cl. 348/333.01

(57) ABSTRACT

Disclosed are systems and methods for optically transferring data. In one embodiment, a system and method pertain to displaying optical data representative of underlying data to be transferred, capturing the displayed optical data, and interpreting the captured optical data to determine the underlying data that the optical data represents.

### BACKGROUND

With the increased computing capabilities being provided in various devices, it is now common to share information between devices. For instance, it is now common to synchronize handheld computing devices such as personal digital assistants (PDAs) with personal computers (PCs). Normally, information is transferred between devices using a wired connection (e.g., universal serial bus (USB)) or using wireless communications via infrared (IR) or radio frequency (RF).

Several computing devices also have image capture capabilities. For example, so-called “eyeball” cameras are used with PCs and mobile telephones are now being produced that can capture image data. In addition, devices that previously were only used to capture images are now being provided with computing capabilities. For instance, digital cameras include a processor and memory so that they function as a type of computer. The combination of computing and image capture capabilities provides a unique opportunity to transfer data optically. Devices that communicate optically would be desirable to provide an alternative method and means for exchanging data between devices.

### SUMMARY

Disclosed are systems and methods for optically transferring data. In one embodiment, a system and method pertain to displaying optical data representative of underlying data to be transferred, capturing the displayed optical data, and interpreting the captured optical data to determine the underlying data that the optical data represents.

### BRIEF DESCRIPTION OF THE DRAWINGS

FIG. 1A is a first embodiment of a system with which data can be optically transferred.

FIG. 1B is a second embodiment of a system with which data can be optically transferred.

FIG. 2 is an embodiment of the architecture of a data destination device shown in FIGS. 1A and 1B.

FIG. 3 is an embodiment of the architecture of data source devices shown in FIGS. 1A and 1B.

FIG. 4 is a flow diagram illustrating an embodiment a method for optically transferring data.

FIGS. 5A-5C provide a flow diagram illustrating an embodiment of operation of an optical data transfer system of a data source device.

FIGS. 6A and 6B are schematic views of a display providing optical data for transfer to a data destination device.

FIGS. 7A and 7B provide a flow diagram illustrating an embodiment of operation of an optical data transfer system of a data destination device.

### DETAILED DESCRIPTION

As identified in the foregoing, devices that incorporate computing and image capture capabilities can potentially be used to optically transfer data. As described in the following, data can be transferred by displaying on a data source device optical data and capturing the optical data with a data destination device. Specifically, optical data can be displayed in several different data patterns on a data source device display and captured by the data destination device. Once the data patterns are captured, they are interpreted to determine the underlying data that the patterns represent. If the patterns are displayed and captured in rapid succession, acceptable data transfer rates may be achieved.

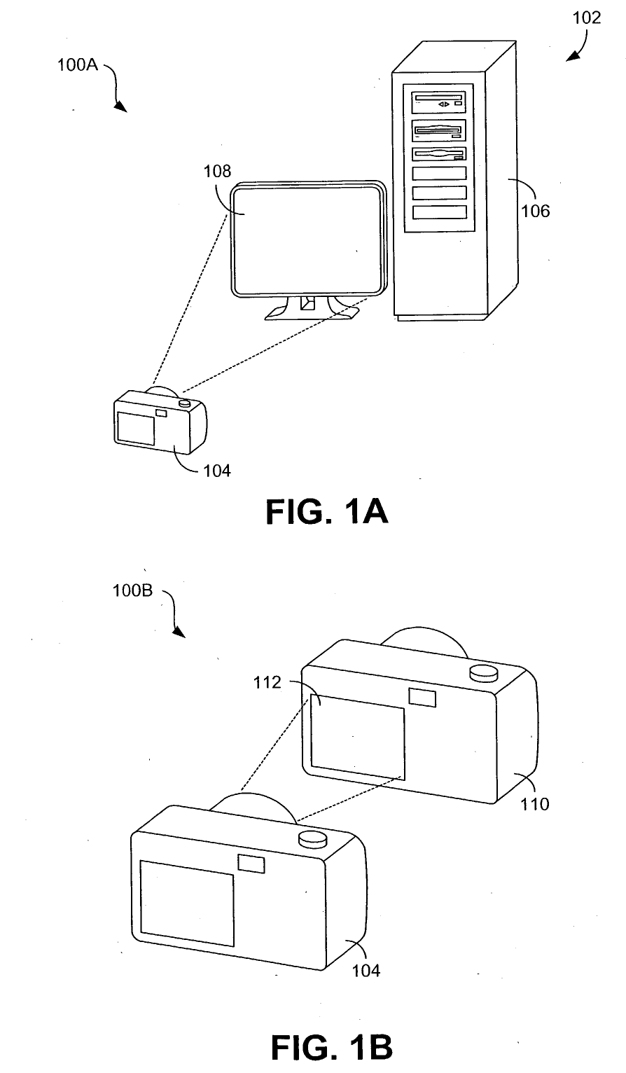

Referring now to the drawings, in which like numerals indicate corresponding parts throughout the several views, FIG. 1A illustrates a first embodiment 100A of a system with which data may be optically transferred. As indicated in the figure, the system comprises a data source device 102 and a data destination device 104. In the example of FIG. 1A, the data source device 102 is a personal computer that comprises a processing/memory unit 106 and a display 108, and the data destination device 104 is an image capture device and, more particularly, a digital camera. As will be apparent from the following discussion, the data source device 102 may generally comprise any device that can store, process, and display optical data, while the data destination device 104 may generally comprise any image capture device that can capture optical data and interpret it so as to determine the information that is represented by the optical data.

FIG. 1B illustrates a second embodiment 100B of a system with which data may be optically transferred. As indicated in the figure, the system of FIG. 1B also comprises a data source device 110 and a data destination device 104. In this embodiment, however, both the data source device 110 and the data destination device 104 are digital cameras. Like the data source device 102 of FIG. 1A, the data source device 110 comprises a display 112 that is used to display optical data.

As noted above with reference to FIG. 1A, the data source device generally comprises a device that can store, process, and display data. Therefore, other examples of data source devices comprise, for example, a notebook computer, a tablet computer, a personal digital assistant (PDA), television in combination with a television control device, and other devices that can display optical data that represents information to be optically transferred to another device. In similar manner, because the data destination device generally comprises a device that can capture and interpret displayed optical data, other types of data destination devices may be used including, for example, a PDA having image capture capability, a mobile telephone having image capture capability, etc. For purposes of convenience, however, the data destination device 104 is assumed to comprise a digital camera for the remainder of this disclosure. One potential advantage of using a digital camera is that such devices can capture high resolution images and therefore may be able to capture optical data with a greater amount of optical data with high accuracy.

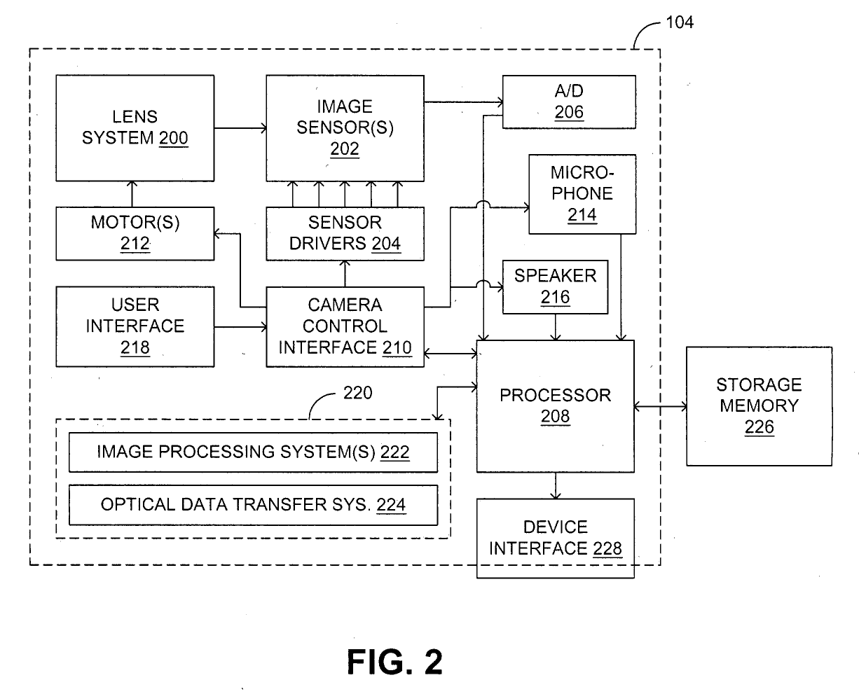

FIG. 2 illustrates an embodiment of the architecture for a data destination device (i.e., an image capture device) such as that depicted in FIGS. 1A and 1B. In particular, illustrated is an embodiment of the architecture of a digital camera that is configured to receive optically transmitted data. As indicated FIG. 2, the camera 104 includes a lens system 200 that conveys images of viewed scenes to one or more image sensors 202. By way of example, the image sensors 202 comprise charge-coupled devices (CCDs) that are driven by one or more sensor drivers 204, or complimentary metal oxide semiconductor (CMOS) sensors. The analog image signals captured by the sensors 202 are then provided to an analog-to-digital (A/D) converter 206 for conversion into binary code that can be processed by a processor 208.

Operation of the sensor drivers 204 is controlled through a camera control interface 210 that is in bi-directional communication with the processor 208. Also controlled through the interface 210 are one or more motors 212 that are used to control operation of the lens system 200 (e.g., to adjust focus, zoom, aperture, or shutter), a microphone 214, and a speaker 216. Operation of the camera control interface 210 may be adjusted through manipulation of a user interface 218. The user interface 218 comprises the various components used to enter selections and commands into the camera 104 such as a shutter-release button and various control buttons provided on the camera.

The digital image signals are processed in accordance with instructions from the camera control interface 210 and the image processing system(s) 222 stored in permanent (non-volatile) device memory 220. Processed images may then be stored in storage memory 226, such as that contained within a removable solid-state memory card (e.g., Flash memory card). In addition to the image processing system(s) 222, the device memory 220 further comprises an optical data transfer system 224 that, as is described in greater detail below, interprets optical data captured by the camera 104. This system 224 is also responsible for calibrating and synchronizing image capture with optical data display by the data source device.

The camera 104 optionally comprises a device interface 228, such as a universal serial bus (USB) connector, that may be used to download images from the camera to another device such as a personal computer (PC) or a printer.

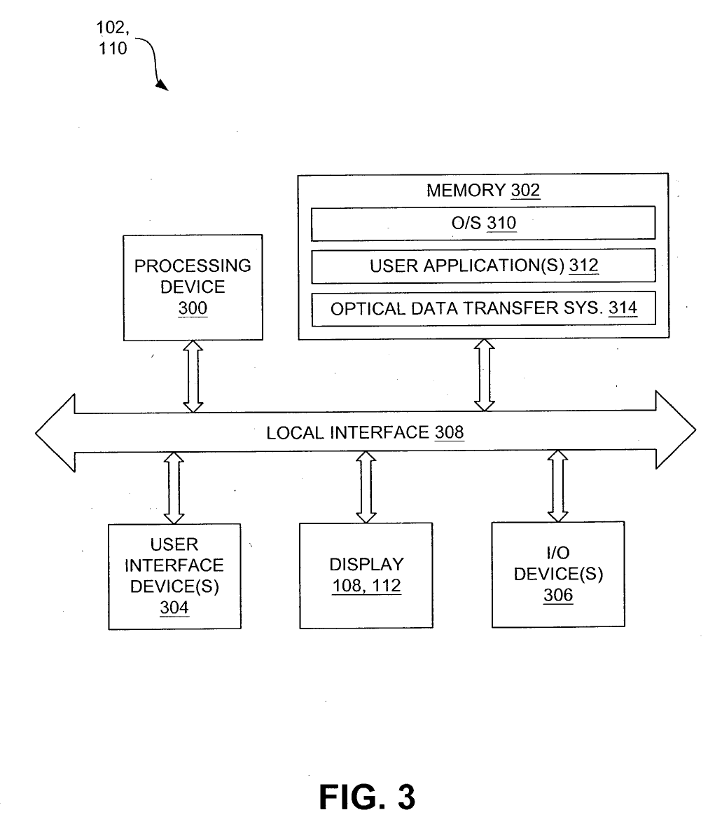

FIG. 3 is a block diagram illustrating an example architecture for a data source device, such as device 102 or 110 shown in FIGS. 1A and 1B, respectively. As indicated in FIG. 3, the data source device comprises a processing device 300, memory 302, user interface devices 304, a display (e.g., display 108 or 112), and one or more input/output (I/O) devices 306. Each of these components is connected to a local interface 308 that, by way of example, comprises one or more internal buses.

The processing device 300 can comprise any custom made or commercially available processor, a central processing unit (CPU) or an auxiliary processor among several processors associated with the data source device 102, a semiconductor based microprocessor (in the form of a microchip), a macroprocessor, or an application specific integrated circuit (ASIC). The memory 302 can include any one of a combination of volatile memory elements (e.g., random access memory) and nonvolatile memory elements (e.g., hard drive, Flash memory, etc.).

The user interface devices 304 comprise those components with which the user can enter input into the data source device 102, 110. By way of example, these components comprise a keyboard, a mouse, control buttons, and/or a touch-sensitive screen.

The display 108, 112 comprises any display with which optical data patterns may be displayed. By way of example, the display comprises an emissive display such as a cathode ray tube (CRT) monitor or a light emitting diode (LED) display, a transmissive display such as a liquid crystal display (LCD), or a reflective display.

With further reference to FIG. 3, the I/O devices 306 are adapted to facilitate the transmission and receipt of information and may include one or more serial, parallel, small computer system interface (SCSI), universal serial bus (USB), and/or IEEE 1394 (e.g., Firewire™) components.

The memory 302 stores various programs (in software and/or firmware) including an operating system (O/S) 310, one or more user applications 312, and an optical data transfer system 314. The operating system 310 controls the execution of other programs and provides scheduling, input-output control, file and data management, memory management, and communication control and related services. The user applications 312 comprise applications that execute on the data source device.

The optical data transfer system 314 controls the operation of the display 102 and the manner in which optical data is presented in the device display. More particularly, the optical data transfer system 314 controls the display elements that are used to display images or “screens” in the display 108, 112 in such a manner so as to convey various information including text data, calibration data, synchronization data, as well as the data to be optically transferred to the data destination device.

The various programs described above can be stored on any computer-readable medium for use by or in connection with any computer-related system or method. In the context of this document, a computer-readable medium is an electronic, magnetic, optical, or other physical device or means that can contain or store a computer program for use by or in connection with a computer-related system or method. The programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

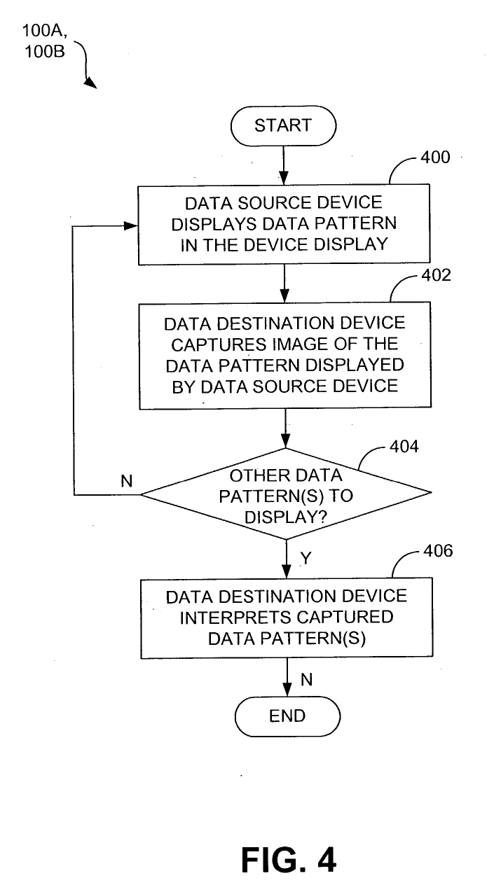

FIG. 4 is a flow diagram illustrating an embodiment of a method for optically transferring data from a data source device to a data destination device. Any process steps or blocks described in the flow diagrams of the present disclosure may represent modules, segments, or portions of program code that includes one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

Beginning with block 400, the data source device displays a data pattern in its display. As described in greater detail below, this data pattern typically comprises a plurality of data points that each comprise one or more display elements or pixels. Displayed may be dark (e.g., black) and light (e.g., white) and/or color pixels that represent binary information (i.e., “1s” and “0s”) such that the displayed data pattern is encoded with information that is to be transferred to the data destination device.

With reference next to block 402, the data destination device captures an image of the data pattern displayed by the data source device. In that multiple data patterns may be used to optically transfer the given data, a plurality of data patterns may be displayed and captured in the manner described above. Accordingly, at decision block 404, it is determined whether other data patterns are to be displayed by the data source device. If so, flow returns to block 400 and continues as described above with data patterns being sequentially displayed and captured.

Once all data patterns have been displayed and captured, flow continues to block 406 at which the data destination device interprets the captured data patterns to determine what data is contained within (i.e., is encoded by) the data patterns. This data can comprise any data that could be transferred to the data destination device using existing data transfer methods such as wired or wireless (e.g., infrared (IR) or radio frequency (RF)) transfer methods. Accordingly, the data can comprise files (e.g., pictures, documents, etc.), device settings, contact information (e.g., email addresses, telephone numbers, etc.), scheduling information (e.g., appointments, task lists, etc.), and the like. After the captured optical data has been interpreted, the optical transfer session is terminated.

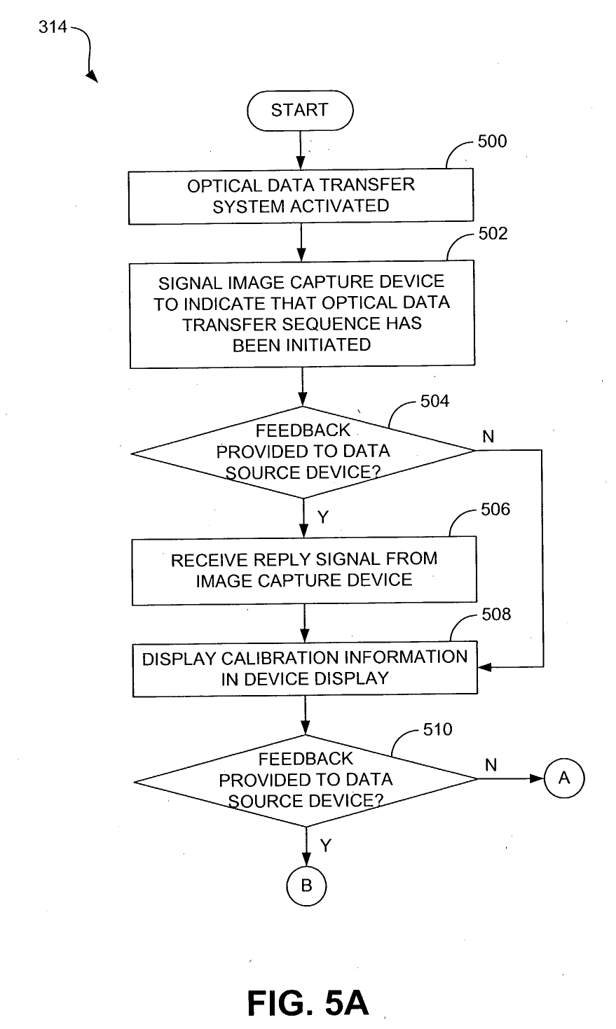

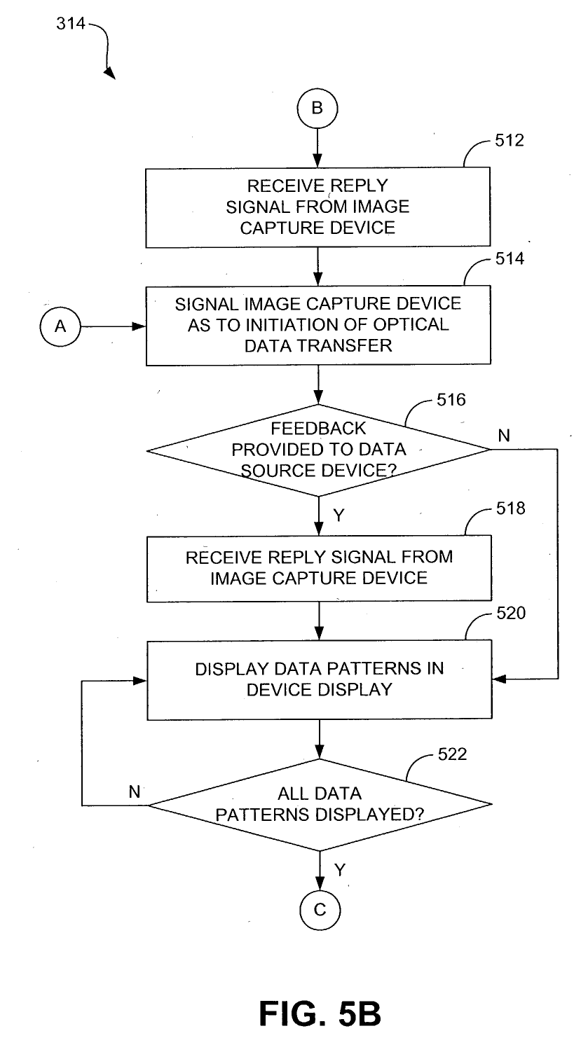

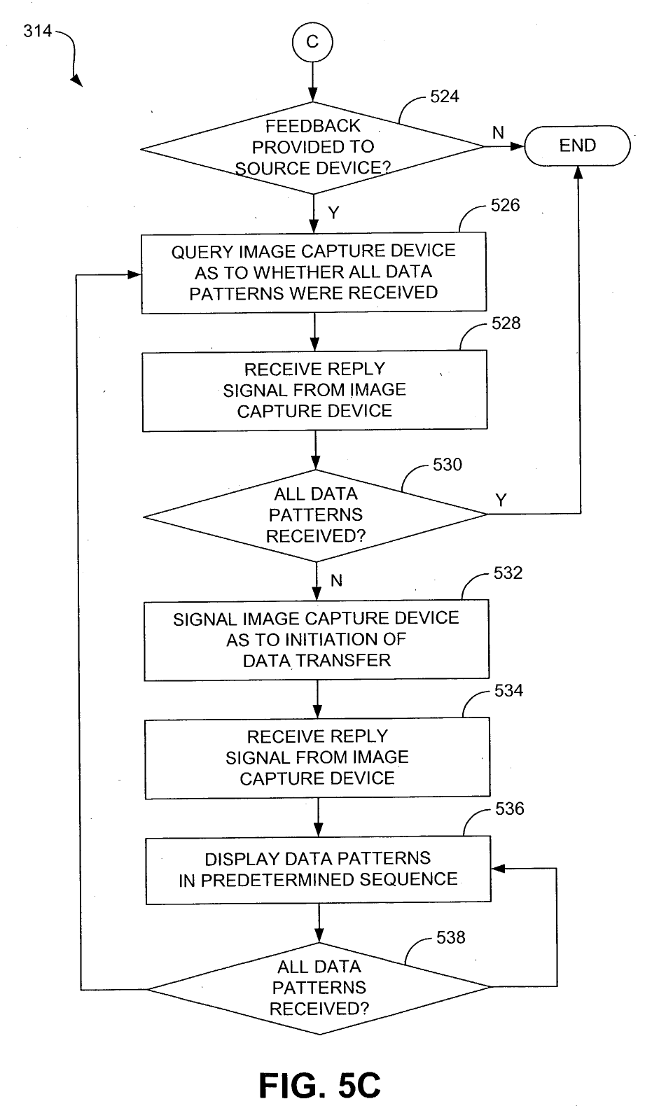

FIGS. 5A-5C illustrate an embodiment of operation of the optical data transfer system 314 of a data source device during optical transfer of data to a data destination device and, more particularly, an image capture device such as a digital camera. Beginning with block 500 of FIG. 5A, the optical data transfer system 314 is activated. This activation can occur in response to the occurrence of several different conditions. By way of example, the system 314 is activated when a user opens a user application on the data source device that facilitates identification and selection of data (e.g., files) to be optically transferred and/or that is used to initiate the optical transfer process.

Once the optical data transfer system 314 of the data source device is activated, it signals the image capture device that the optical data transfer sequence has been initiated, as indicated in block 502. Although this signal can be delivered using existing types of communication paths such as a wired path (e.g., USB cable) or a wireless path (e.g., IR or RF link), the image capture device can be signaled without such means so that cables and/or transceivers are unnecessary. This not only simplifies the data transfer process for the user, but further potentially simplifies the devices in that the need for additional hardware is obviated. Instead, existing components of the devices are leveraged to send, as well as receive, the signal.

In one example embodiment, the destination device starts sampling images, waiting for the transmission of data to start. The source device displays the first data screen, or a calibration screen (described below). The destination device recognizes the data or calibration screen, thus starting the sequence. In another example embodiment, the data source device signals the image capture device with an optical signal generated with the data source device display. In such a case, the signal may comprise, for example, a flashing image (e.g., alternating black and white screens). In yet another example embodiment, the signal is an audible signal, for instance comprising a series of beeps or tones, that is emitted by a speaker of the data source device. In any case, however, the nature of the signal may depend upon the capabilities of the data source device (i.e., capability to send a signal) as well as those of the image capture device (i.e., capability to receive a signal).

Flow from this point depends upon whether feedback as to the progression of data transfer process is to be provided to the data source device from the destination device. For instance, the destination device can provide feedback indicating it is ready to receive data and/or that data has been correctly received. Whether such feedback will be provided may depend upon the capability of the image capture device to send reply signals as well as the capability of the data source device to receive these reply signals. With reference to decision block 504, if no such feedback is to be provided, flow continues down to block 508 described below.

In such a case, the optical data transfer process will proceed without feedback (i.e., a feedback loop) to the data source device. Note that it is assumed that the destination device can capture and process images at a rate faster than they are displayed on the source device. The destination device will thus see all of the displayed frames. In such a case, the destination device will occasionally capture duplicate frames, which are simply ignored. Therefore, the data source device will complete its tasks irrespective of whether the image capture device is prepared to capture and/or correctly captures the optical data presented in the data source device display.

If feedback is to be provided to the data source device, however, flow continues to block 506 at which the data source device receives a reply signal from the image capture device. Assuming that the image capture device is prepared to receive optical data, this reply signal indicates to the data source device that the optical data transfer system may proceed with the transfer process. Notably, if the original signal sent by the data source device was an optical signal (e.g., a flashing screen), the reply signal from the image capture device further indicates to the data source device that the image capture device is “reading” the data source device display. Therefore, an optical signal from the data source device may be preferable in some embodiments.

If the image capture device is not prepared to receive optical data for whatever reason, the image capture device can indicate this condition to the data source device in its reply signal with a “not ready” signal so that the optical data transfer process is delayed until such time when the image capture device is ready.

Assuming that a reply signal is sent by the image capture device, the nature of the signal depends upon the capabilities of both the image capture device and the data source device. In one embodiment, this reply signal comprises an audible signal such as a series of beeps or tones emitted by a speaker of the image capture device and received by a microphone of the data source device.

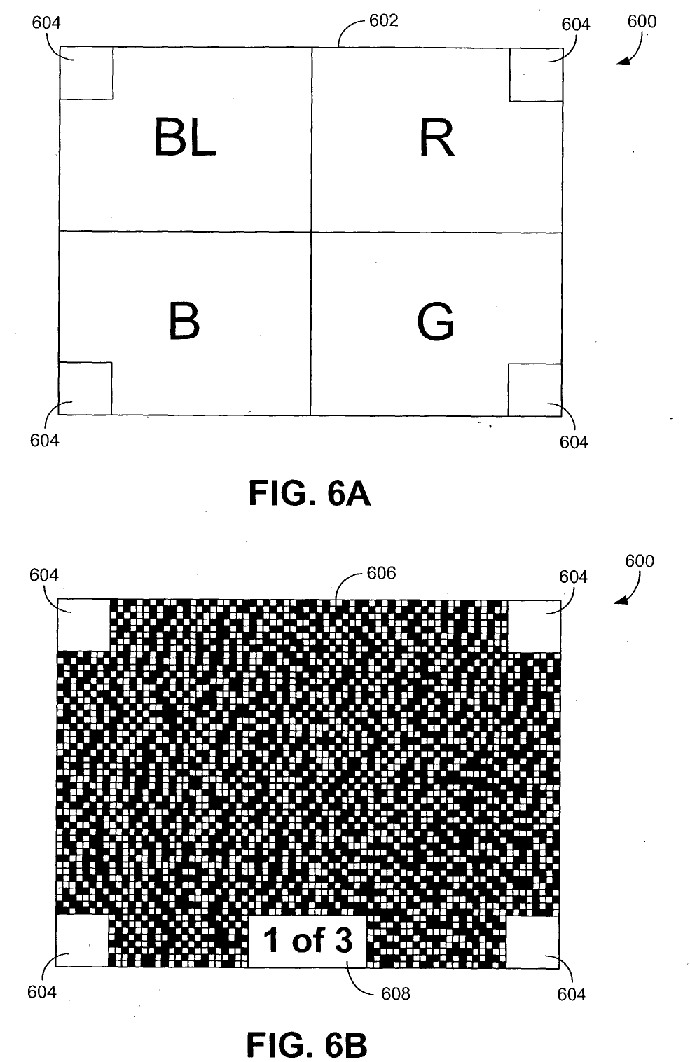

After the reply signal has been received (block 506), or if no feedback was to be provided to the data source device (block 504), the optical data transfer system 314 displays calibration information in the device display, as indicated in block 508. This calibration information comprises optical data that is used by the image capture device to make various determinations. For example, the image capture device can determine from the optical data the bounds of the display such that the zoom and focus of the image capture device can be set so attention is only given to the optical data presented in the display, as opposed to background information in the viewed scene (i.e., optical noise). The bounds of the display can be conveyed to the image capture device by, for example, displaying alignment guides in the display. An example calibration screen 602 that may be shown in a data source device display 600 is depicted in FIG. 6A. As indicated in this figure, four solid-color alignment blocks 604 are provided in the four comers of the rectangular display 600. Assuming that the image capture device is configured to “look” for these blocks 604, the vertical and horizontal extent of the display 600 may be determined when these blocks are identified by the image capture device.

The calibration screen 604 may further include color fields (e.g., quadrants of the display) in which solid colors such as black (BL), red (R), blue (B), and green (G) are displayed. If the image capture device is configured such that it expects to “see” these colors in these fields of the display 600, the image capture device will have the optical data used to compensate for the particularities of the data source device display as well as the particular lighting environment in which the optical data transfer is to take place. Accordingly, a red data point presented in the data source device display will be correctly interpreted as a red data point by the image capture device, a blue data point will be correctly interpreted as a blue data point, and so forth. This color correction can be achieved by applying a 3 by 3 color matrix operation. Correcting this “color crosstalk” increases the reliability of the information transfer.

Other information may further be provided to the image capture device using the data source device display. This information can include the rate at which data patterns will be presented in the display during the optical data transfer. For example, if standardized display rates are used (e.g., slow, medium, and fast), one such rate may be specified using an appropriate optical indication provided in the display (not shown). For example, a few data points (e.g., pixels) may be used to convey the selected display rate. By providing this information, the image capture device can synchronize its rate of image capture with the rate of data pattern display so that each data pattern can be captured. It will be appreciated that any other information relevant to the optical data transfer process may be conveyed to the image capture device in similar manner, if desired.

With reference back to FIG. 5A, flow from this point once again depends upon whether feedback is to be provided to the data source device. With reference to decision block 510, if no such feedback is to be provided, flow continues to block 514 of FIG. 5B described below. If, on the other hand, feedback is to be provided, flow continues to block 512 of FIG. 5B at which a reply signal is received from the image capture device. Assuming that all required calibration information was received, this reply signal will indicate to the optical data transfer system 314 that it may proceed with the next step of the transfer process. If, on the other hand, the reply signal indicates that some information was not received, an attempt to send or resend this information (e.g., by displaying it in the display) may be made.

Referring next to block 514, the optical data transfer system signals the image capture device as to the initiation of the optical transfer of data. In other words, the system 314 signals the image capture device that the data patterns representing the data to be transferred are about to be sequentially displayed. Once more, flow at this point depends upon whether the image capture device is to provide feedback to the data source device (decision block 516). If so, the optical data transfer system 314 receives a reply signal from the image capture device, as indicated in block 518, which identifies whether the image capture device either is or is not prepared to capture these data patterns. Assuming that the image capture device is prepared, or if no feedback was to be provided in the first place (block 516), flow continues to block 520 at which the data source device displays data patterns in the device display in a predetermined sequence at a predetermined rate.

Generally, a data pattern comprises encoded binary data that includes a plurality of data points that comprise at least one data pixel. Using multiple pixels per displayed data point allows lower resolution sensors in the destination devices, such as mobile phones and PDAs. It also allows very casual or sloppy alignment between the two devices during the transfer. To convey a greater amount of data per data pattern, each display pixel comprises a separate data point that may be read by the image capture device using a bilevel binary scheme. This case is especially feasible with modern digital cameras, which have very high resolution sensors (5 or more megapixels). To such a case, three bits of data can be displayed per display pixel. To increase bit depth, multiple colors, shades of colors, and/or color brightnesses may be used to achieve multilevel coding. For example, if four shades of a given color are used, then six bits of data can be conveyed per display pixel. Irrespective of the colors, shades, and brightness of the display pixels, the optical data presented in the display appears to the human observer as noise or “snow.”

An example data pattern screen 606 is depicted in FIG. 6B. In this example, pixels are shown as either black (e.g., “1”) or white (e.g., “0”). As shown in this figure, the data pattern screen 606 may further comprise alignment blocks 604 that are used to convey the bounds of the display 600 to the image capture device. In addition, the data pattern screen 606 may include a user interface 608 in which the progress of the optical data transfer is conveyed to the user. For instance, in the example of FIG. 6B, the user interface 608 indicates that item “1 of 3” is currently being transferred. In such a case, the items may comprise pages of a document, pictures of an album, contacts in a contact list, etc. If a user feedback element such as the interface 608 is displayed, the image capture device will be configured to ignore the portion of the display that contains this feedback as being beyond the bounds of the data pattern.

In addition to the raw data, alignment information, and user feedback, the data pattern screen can comprise information about the pattern's identity for tracking purposes. For instance, if 500 data patterns are to be transferred, a portion of each data pattern (e.g., a few pixels of the pattern) can contain information as to which one of the 500 patterns that particular pattern is. In such a case, this information could indicate that a particular pattern is “425 of 500,” or equivalent. With this information, the image capture device can determine whether one or more of the data patterns was not received for some reason.

The speed with which the data patterns are displayed and captured, as well as the manner with which data is conveyed in the data pattern (e.g., number of pixels or data points used, colors used, etc.) dictate the data transfer rate that can be achieved. To cite a simple example, assuming a display having 400×500 pixels, and assuming a display/capture frame rate of 30 frames per second (fps), the pixel rate is 6 million pixels per second. Assuming only one bit per pixel (each pixel is either on or off) and 8 bits per byte, a transfer rate of 750 kilobytes per second (KB/s) or greater can be achieved. Typical transfer rates may be somewhat lower due to the overhead of the previously described alignment marks, user feedback, flow control, turnaround delays, etc.

With reference back to FIG. 5B, it is next determined whether all data patterns have been displayed, as indicated in decision block 522. In other words, it is determined whether all of the data to be transferred to the image capture device has been conveyed using the sequential data patterns. If not, flow returns to block 520 and the remaining data patterns are displayed. If all data patterns have been displayed, however, flow continues to decision block 524 of FIG. 5C at which it is once again determined whether feedback is to be provided to the data source device. If not, all data patterns have been displayed and no signal confirming their receipt is expected. In such a case, flow for the optical data transfer session is terminated.

If feedback is to be provided to the optical data transfer system 314, flow continues to block 526 and the system queries the image capture device as to whether all data patterns have been received. At block 528, the image capture device provides a reply to the query and, at decision block 530, the optical data transfer system 314 determines whether all data patterns were received by the image capture device. If so, the optical data transfer process has been successfully completed and flow for the session is terminated. If, on the other hand, one or more data patterns were not received, flow continues to block 532 and the optical data transfer system 314 signals the image capture device that it is about to initiate another data transfer (block 534), receives a reply signal from the image capture device (block 536), and, assuming that the image capture device is prepared to capture the missing data patterns, displays the data patterns (block 538).

At this point, flow returns to block 526 and the image capture device is again queried as to whether all data patterns have been received. If not (block 530), flow continues through the loop comprising blocks 526-538 until all data patterns have been successfully received by the image capture device.

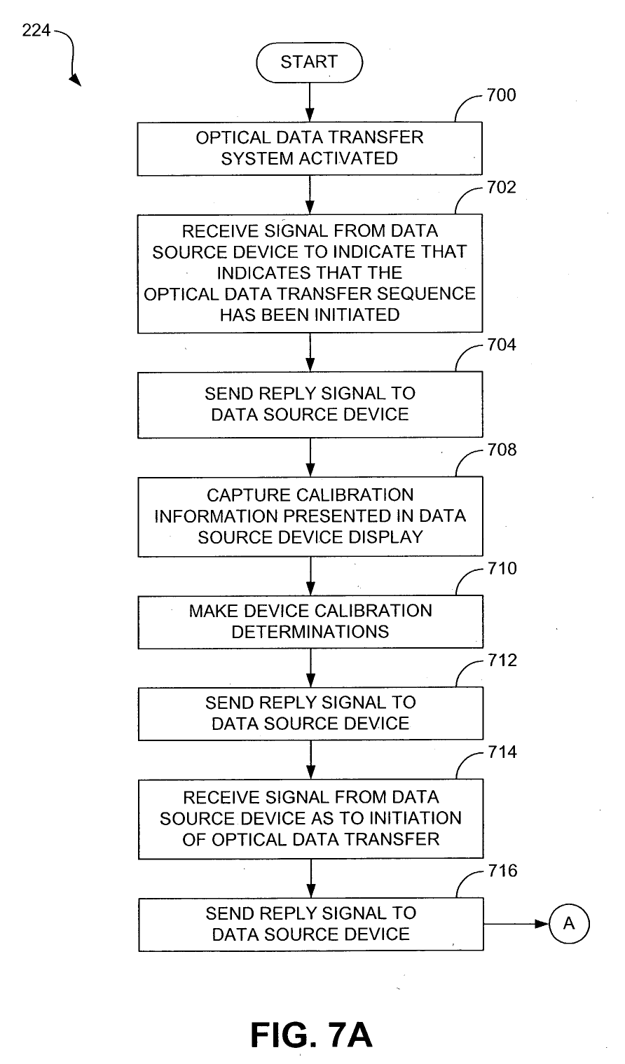

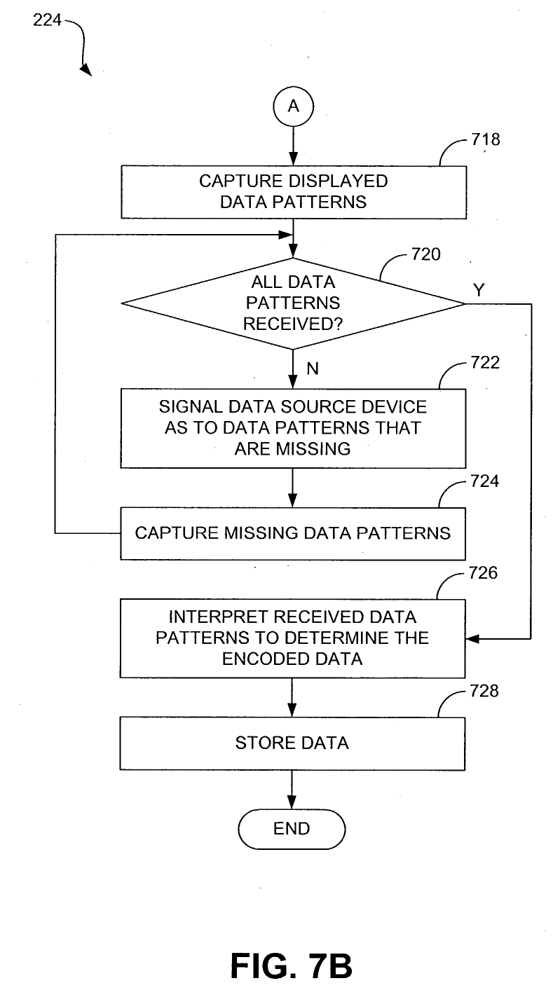

FIGS. 7A-7B illustrate an embodiment of operation of the optical data transfer system 224 of the data destination device, i.e. the image capture device. Generally, flow for the optical data transfer system 224 complements the flow for the optical data transfer system 314 described above in relation to FIGS. 5A-5C. In FIGS. 7A-7B, however, it is presumed that feedback is provided to the data source device from the image capture device.

Beginning with block 700 of FIG. 7A, the optical data transfer system 224 is activated. This activation can also occur in response to the occurrence of several different conditions. By way of example, the system 224 is activated when a user places the image capture device in an optical data transfer mode in which the device is configured to receive (i.e., capture) optical data displayed by the data source device.

Once the optical data transfer system 224 of the image capture device is activated, it receives a signal from the data source device that identifies that the optical data transfer sequence has been initiated, as indicated in block 702. Again, this signal may comprise an optical signal, audible signal, or other manner of signal. Irrespective of the type of signal that is received, the optical data transfer system 224 sends a reply signal to the data source device, as indicated in block 704, that indicates whether the image capture device is prepared to capture optical data. By way of example, situations in which the image capture device is not so prepared include a low battery condition, a condition in which other tasks (e.g., image processing) are using processing resources, etc.

Assuming that the image capture device is prepared to capture optical data presented in the data source device display, flow continues to block 708 at which the image capture device captures (and the optical data transfer system 224 receives) calibration information that is presented in the data source device display. As described above, this calibration information comprises optical data that is used to make various determinations, as indicated in block 710, such as the bounds of the data source device display, the “look” of certain calibration colors (e.g., black, red, blue, and green), the rate at which data patterns will be presented in the display during optical data transfer, etc. The calibration determinations made by the optical data transfer system 224 may then be used to adjust image capture device settings (e.g., zoom, capture rate, etc.) such that the device is calibrated to capture all optical data.

Referring next to block 712, the optical data transfer system 224 signals the data source device as to whether all required calibration information has been received. If not, the optical data transfer system 224 may further indicate in the reply signal what pieces of information are missing so that these may be provided by the data source device. Assuming that all information has been received, however, flow continues to block 714 at which the optical data transfer system 224 receives a signal from the data source device as to the initiation of the optical transfer of data. Assuming that the image capture device (and the optical data transfer system 224) is prepared, the optical data transfer system 224 sends a reply signal, at block 716, to the data source device indicating the ready condition and then, at block 718 of FIG. 7B, the data patterns displayed by the data source device are captured.

Next, with reference to decision block 720, the optical data transfer system 224 determines, either upon receiving a query from the data source device or on its own, whether all data patterns have been received. If so, the optical data transfer is complete and flow continues down to block 726 described below. If not, however, the optical data transfer system 224 signals the data source device as to the data patterns that are missing, as indicated in block 722. The data transfer device may then redisplay these data patterns so that, at block 724, the missing data patterns can be captured. Next, flow returns to decision block 720 and continues in the loop of blocks 720-724 until all data patterns have been received by the optical data transfer system 224.

With reference to block 726, the data patterns are interpreted (i.e., decoded) to determine the underlying encoded data the captured patterns contain in similar manner to interpreting encoded information from, for instance, a two-dimensional bar code such as those used in the shipping industry. This step is completed by analyzing the data patterns in view of one or more decoding algorithms of the optical data transfer system 224. As noted above, this interpretation may yield various different types of data such as, for example, files (e.g., pictures, documents, etc.), device settings, contact information (e.g., email addresses, telephone numbers, etc.), scheduling information (e.g., appointments, task lists, etc.), and the like. Finally, in block 728, the data may be stored to memory for later use.

While particular embodiments of the invention have been disclosed in detail in the foregoing description and drawings for purposes of example, it will be understood by those skilled in the art that variations and modifications thereof can be made without departing from the scope of the invention as set forth in the following claims.

What is claimed is:

1. A method for optically transferring data, comprising:
displaying optical data representative of underlying data to be transferred;
capturing the displayed optical data; and
interpreting the captured optical data to determine the underlying data that the optical data represents.

2. The method of claim 1, wherein displaying optical data comprises displaying optical data in a display of a first device.

3. The method of claim 2, wherein capturing the displayed optical data comprises capturing the displayed optical data with a second device such that data is optically transferred from the first device to the second device.

4. The method of claim 1, wherein displaying optical data comprises displaying at least one data pattern in which the underlying data is encoded.

5. The method of claim 4, wherein displaying at least one data pattern comprises displaying a plurality of data points, each data point being formed by at least one display pixel.

6. The method of claim 5, wherein each data point represents one bit of data.

7. The method of claim 5, wherein each data point represents more than one bit of data.

8. The method of claim 5, wherein each display pixel is a separate data point.

9. The method of claim 1, wherein capturing the displayed optical data comprises capturing the displayed optical data using a digital camera.

10. The method of claim 1, wherein interpreting the captured optical data comprises analyzing the captured optical data using a decoding algorithm.

11. The method of claim 1, further comprising displaying optical data representative of calibration information, and capturing that optical data.

12. The method of claim 11, wherein displaying optical data representative of calibration information comprises displaying at least one of an alignment guide, a color field, and data indicative of a pattern display rate.

13. The method of claim 1, further comprising synchronizing display and capture rates before any optical data is displayed.

14. The method of claim 1, further comprising providing feedback as to progression of the data transfer process.

15. A system for optically transferring data, comprising:
a data source device including a display, the data source device being configured to present in the display optical data that is representative of underlying data that is to be transferred; and
a data destination device comprising image capture components, the data destination device being configured to capture images of the optical data that is presented in the data source device display, and to interpret the optical data that is captured to determine what underlying data the optical data represents.

16. The system of claim 15, wherein the data source device comprises one of a digital camera, personal computer, a notebook computer, a personal digital assistant, and a tablet computer.

17. The system of claim 15, wherein the data destination device comprises one of a digital camera, personal digital assistant, and a mobile telephone.

18. The system of claim 15, wherein the data source device is configured to present a plurality of data patterns in the display in rapid succession.

19. The system of claim 15, wherein the data source device is configured to present in the display calibration information that can be captured by the data destination device.

20. A system for optically transferring data, comprising:
means for displaying a data pattern in which is encoded data that is to be transferred;
means for capturing an image of the displayed data pattern; and
means for decoding the data pattern to determine the underlying data.

21. The system of claim 20, wherein the means for displaying comprise a display of a data source device.

22. The system of claim 20, wherein the means for capturing comprise an image capture device.

23. The system of claim 20, wherein the means for decoding comprise a decoding algorithm that executes on the image capture device.

24. A data source device, comprising:
a display;
a processor that controls the display; and
memory that stores an optical data transfer system, the optical data transfer system being configured to generate optical data representative of underlying data also stored in memory that is to be transferred to another device, and to display the optical data in the display.

25. The device of claim 24, wherein the optical data transfer system is configured to display data patterns in which the underlying data is encoded.

26. The device of claim 25, wherein the display comprises a plurality of pixels and the data patterns comprise a plurality of data points, each data point being formed by at least one display pixel.

27. The device of claim 25, wherein the optical data transfer system is configured to display optical data representative of calibration information.

28. The device of claim 24, wherein the optical data transfer system is configured to receive feedback as to progression of the data transfer process from another device.

29. A data destination device, comprising:
image capture components configured to capture optical data displayed by a data source device;
a processor that controls the image capture components; and
memory that stores an optical data transfer system, the optical data transfer system being configured to interpret the optical data captured by the image capture components to determine underlying data that is encoded within the optical data.

30. The device of claim 29, wherein the optical data transfer system is configured to provide feedback as to progression of the data transfer process to a data source device.

31. A system for optically transferring data, comprising:
a data source device including a display, the data source device being configured to present in the display optical data that is representative of underlying data that is to be transferred; and
a data destination device comprising image capture components, the data destination device being configured to capture images of the optical device that is presented in the data source device display, and to provide feedback to the data source device.

32. The system of claim 31, wherein the data source device comprises one of a digital camera, personal computer, a notebook computer, a personal digital assistant, and a tablet computer.

33. The system of claim 31, wherein the data destination device comprises one of a digital camera, personal digital assistant, and a mobile telephone.

34. The system of claim 31, wherein the data source device is configured to present a plurality of data patterns in the display in rapid succession.
